(19) United States
(12) Patent Application Publication
(10) Pub. No.: US 2026/0161381 A1
(43) Pub. Date: Jun. 11, 2026

(54) INFORMATION PROCESSING APPARATUS AND CONTROL METHOD

(71) Applicant: Lenovo (Singapore) Pte. Ltd., Singapore (SG)

(72) Inventors: Atsunobu Nakamura, Kanagawa (JP); Kazuya Shibayama, Kanagawa (JP); Mao Nakabayashi, Kanagawa (JP); Taiki Koide, Kanagawa (JP)

(73) Assignee: Lenovo (Singapore) Pte. Ltd., Singapore (SG)

(21) Appl. No.: 19/309,140

(22) Filed: Aug. 25, 2025

(30) Foreign Application Priority Data
Sep. 2, 2024 (JP) 2024-150868

(51) Int. Cl. G06F 8/65; G06F 1/324

(52) U.S. Cl. CPC G06F 8/65; G06F 1/324

(57) ABSTRACT

A host system that executes update processes of firmware is configured to: measure a processing speed for each of the update processes; and decrease a power limit value of the host system when an amount of decrease in the processing speed with respect to an amount of decrease in the power limit value is equal to or less than a predetermined reference amount.

### CROSS-REFERENCE TO RELATED APPLICATIONS

This application claims priority to Japanese Patent Application No. 2024-150868 filed on Sep. 2, 2024, the contents of which are hereby incorporated herein by reference in their entirety.

### TECHNICAL FIELD

Embodiments of the present invention relate to an information processing apparatus and a control method, and relates to, for example, updating of firmware of a device constituting the apparatus.

### BACKGROUND

In an information processing apparatus such as a personal computer (PC), firmware of a device constituting a part of the apparatus may be updated. The firmware may be incorporated into hardware in order to control basic functions. The updating of the firmware is usually performed after stopping operations of the device to be updated. For that reason, it is desired to shorten an update time as much as possible.

For example, based on information indicating an execution sequence of a plurality of update processes related to a plurality of modules corresponding to a target device that includes the plurality of modules in which the update processes of software are performed, an information processing apparatus disclosed in Japanese Unexamined Patent Application Publication No. 2016-110372 specifies one or more first process blocks, each of which is one process block including update processes to be executed in parallel from among the plurality of update processes, and estimates an update time for each of the specified first process blocks by using information indicating update times respectively related to the plurality of update processes. Then, based on at least one of the information indicating the update times and the estimated update time for each of the first process blocks, the information processing apparatus estimates an update time of the target device.

The information processing apparatus generally has the higher processing speed as its clock frequency is higher so as to increase power consumption. However, a quantitative relationship between the power consumption and the update time of the firmware is not necessarily clear. For example, even if a power limit value that is a parameter of the power consumption is increased, the update time of the firmware may not be reduced. The power consumption of the information processing apparatus is increased if the power limit value is increased, but a waste of power may be caused without reducing the update time of the firmware.

### SUMMARY

An information processing apparatus according to the fist aspect of the present invention includes a host system that executes update processes of firmware, the host system being configured to: measure a processing speed for each of the update processes; and decrease a power limit value of the host system when an amount of decrease in the processing speed with respect to an amount of decrease in the power limit value is equal to or less than a predetermined reference amount.

In the information processing apparatus, the host system may be configured to decrease the power limit value by a predetermined amount of decrease when an amount of decrease from a processing speed of a previous update process to a processing speed of a latest update process among the processing speeds of the update processes is equal to or less than the reference amount.

In the information processing apparatus, a rate of decrease of the power limit value may be constant.

In the information processing apparatus, the host system may be configured to increase the power limit value when the amount of decrease from the processing speed of the previous update process to the processing speed of the latest update process exceeds the reference amount.

In the information processing apparatus, the firmware may include a basic input/output system (BIOS).

The information processing apparatus may further include an embedded controller, and the firmware may include firmware of the embedded controller.

A control method according to the second aspect of the present invention is executed by an information processing apparatus that executes update processes of firmware, and the control method includes: measuring a processing speed for each of the update processes; and decreasing a power limit value of a host system when an amount of decrease in the processing speed with respect to an amount of decrease in the power limit value is equal to or less than a predetermined reference amount.

Embodiments of the present invention can reduce the power consumption in the update process while suppressing the prolongation of the update time of the firmware.

### BRIEF DESCRIPTION OF THE DRAWINGS

FIG. 1 is a schematic block diagram illustrating a configuration example of an information processing apparatus according to one or more embodiments;

FIG. 2 is a schematic block diagram illustrating a functional configuration example of a host system according to one or more embodiments;

FIG. 3 is a diagram illustrating power consumption during an update process of firmware;

FIG. 4 is a flowchart illustrating a power limit value setting process according to one or more embodiments; and

FIG. 5 is an explanatory diagram illustrating an execution example of the power limit value setting process according to one or more embodiments.

### DETAILED DESCRIPTION

Hereinafter, embodiments of the present invention will be described with reference to the accompanying drawings. A configuration example of an information processing apparatus 1 according to one or more embodiments will be described.

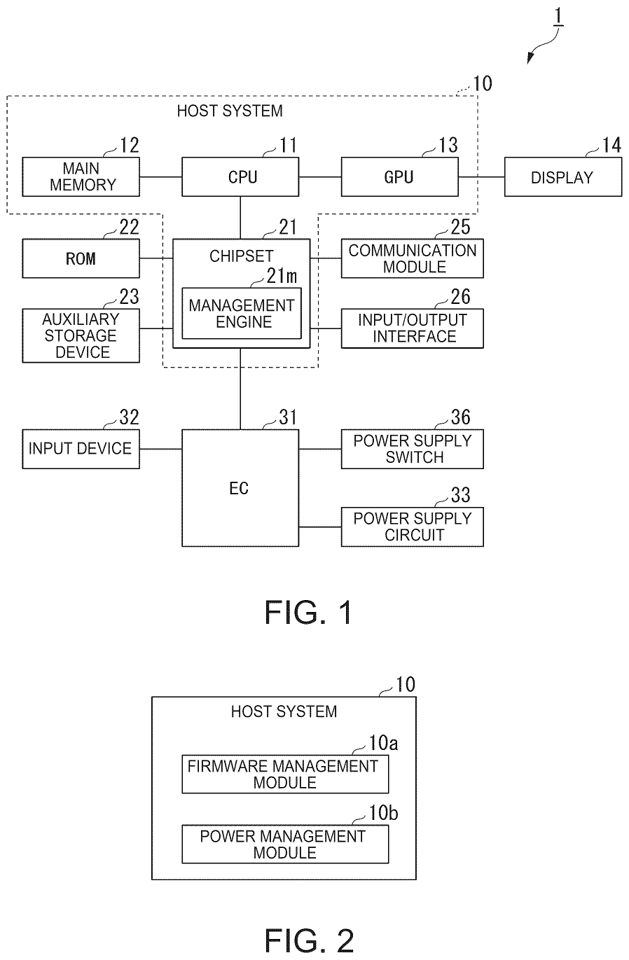

FIG. 1 is a schematic block diagram illustrating a configuration example of the information processing apparatus 1 according to one or more embodiments.

In the example of FIG. 1, the information processing apparatus 1 is configured as a general-purpose personal computer (PC).

The information processing apparatus 1 includes a host system 10, a display 14, a read only memory (ROM) 22, an auxiliary storage device 23, a communication module 25, an input/output interface 26, an embedded controller (EC) 31, an input device 32, a power supply circuit 33, and a power supply switch 36.

The host system 10 is a computer system that forms the core of the information processing apparatus 1. The host system 10 includes a central processing unit (CPU) 11, a main memory 12, a graphic processing unit (GPU) 13, and a chipset 21. In the present invention, hardware constituting the host system 10 may be called a “host device”.

The CPU 11 controls all the operations of the information processing apparatus 1. In other words, the CPU 11 is a core processor that executes arithmetic processing instructed by various instructions (commands) described in software (programs). The CPU 11 executes reading and writing data from and to storage medium such as the main memory 12 and the auxiliary storage device 23, reading data from the ROM 22, the input and output to and from another device, and the like. The programs executed by the CPU 11 include, for example, an operating system (OS), firmware, a device driver (may be simply called “driver” in the present invention), a utility program, an application program, and the like. Note that, in the present invention, executing processing instructed by instructions described in a program may be called “executing the program”, “the execution of the program”, or the like.

System firmware is a program for executing the input and output to and from hardware resources. The system firmware includes a unified extensible firmware interface basic input/output system (BIOS). The BIOS includes a system BIOS based on the unified extensible firmware interface (UEFI) standard. The present invention may refer to the system firmware as the BIOS. The CPU 11 starts a boot process at the time of the application of power. The CPU 11 executes a boot loader to read the BIOS from the ROM 22. The CPU 11 executes power-on self test (POST) processing in accordance with the BIOS. The POST processing includes processes such as basic device initialization, consistency verification, device detection, system setting, and system startup (OS startup).

The main memory 12 is a writable memory that is used as a reading area of an execution program of the CPU 11 or a working area for writing the processing data of the execution program. The main memory 12 is configured of a plurality of DRAM (dynamic random access memory) chips, for example. The CPU 11 and the main memory 12 are minimum hardware constituting the host system 10.

The GPU 13 is an arithmetic processing unit for mainly realizing functions associated with image display. The GPU 13 processes (image processing) drawing instructions issued from the CPU 11, and writes display data indicating the obtained display information to its own video memory. The GPU 13 sequentially reads the written display data from the video memory, and outputs the read display data to the display 14. The GPU 13 may share some of the processes with the CPU 11. The GPU 13 may be integrated with the CPU 11 to be formed on the same core, or may be formed on a core separate from the CPU 11. The GPU 13 may execute parallel arithmetic processing other than image processing, and may share some of the processes with the CPU 11.

The display 14 displays a display screen based on the display data input from the GPU 13. The display 14 may be any of a liquid crystal display (LCD), an organic light emitting diode (OLED) display, and the like, for example.

The chipset 21 includes a plurality of controllers, and can be connected to a plurality of devices to be able to input and output various types of data. The controllers provided in the chipset 21 may be any of a universal serial bus (USB), a serial peripheral interface (SPI) bus, a PCI-Express bus, and the like, for example. In the example of FIG. 1, the chipset 21 is connected to the ROM 22, the auxiliary storage device 23, the communication module 25, the input/output interface 26, and the EC 31.

The chipset 21 includes a management engine 21m. The management engine 21m has functions related to the maintenance of the host system 10. The management engine 21m has, for example, functions providing some or all of a low power consumption service, an out-of-band management service, a feature licensing service, an anti-theft function, a protected audio-video path, and the like. The management engine 21m is a microcontroller separate from the host system 10. The management engine 21m is independent of the power state of the host system 10, and functions before the main OS is completely started by the host system 10 from immediately after the application of power. The management engine 21m reads firmware (may be called “MEFW (management engine firmware) ” in the present invention) for the management engine 21m from the ROM 22 immediately after the application of power, and executes the read MEFW to provide its function.

The ROM 22 mainly stores therein firmware. The firmware stored in the ROM 22 includes BIOS, MEFW, and other firmware related to individual devices. The ROM 22 is configured to include a rewritable nonvolatile memory such as an electrically erasable programmable read only memory (EEPROM) and a flash ROM.

The auxiliary storage device 23 stores therein various types of data used for the processing of the host system 10, various types of data acquired by the processing, various programs, and the like. The auxiliary storage device 23 may be any of a solid state drive (SSD), a hard disk drive (HDD), and the like, for example.

The communication module 25 is connected to a communication network so as to be able to transmit and receive various types of data wirelessly or by wire. The communication module 25 communicates various types of data with other devices connected to the communication network. The communication module 25 is, for example, a wireless LAN module connected to a wireless LAN.

The input/output interface 26 is connected to various devices so as to be able to input and output data by wire or wirelessly. For example, the input/output interface 26 includes a connector (USB connector) for inputting and outputting data by wire in accordance with the USB regulations.

The EC 31 is a controller configured to monitor and control operations of various devices connected to the EC regardless of operating states of the host system 10. The EC 31 includes a CPU, a ROM, a RAM, a timer, and an input/output interface, separately from the host system 10. Devices having a lower data transfer rate than the chipset 21 may be connected to the EC 31. In the example of FIG. 1, the input device 32, the power supply circuit 33, and the power supply switch 36 are connected to the EC 31.

The EC 31 reads firmware (may be called “ECFW (embedded controller firmware)” in the present invention) for the EC 31 from its own ROM, and executes the read ECFW to provide its function. The EC 31 may cause the ROM 22 to previously store the ECFW instead of its own ROM, and execute the read ECFW. In this regard, however, the ROM 22 is required to be started at the time of startup of the EC 31.

The input device 32 detects an operation of a user, generates an operation signal in accordance with the detected operation, and outputs the operation signal to the EC 31. The input device 32 may be any of a keyboard, a touch pad, and the like, for example.

The power supply circuit 33 includes a voltage converter. The voltage converter converts a voltage of DC power supplied from an external power supply or a battery (not illustrated) into a voltage required for operations of the devices constituting the information processing apparatus 1, and supplies power having the converted voltage to a provision destination device. The power supply circuit 33 executes the supply of power to the device in accordance with the control of the EC 31. The power supply circuit 33 includes a charger. The charger charges the battery with an amount of the remaining power that is not consumed by the devices out of amounts of the power supplied from the external power supply. When power is not supplied from the external power supply or when power supplied from the external power supply does not satisfy a demand, the charger supplies the power discharged from the battery to the devices. The battery is charged with power supplied from the power supply circuit 33 or discharges power accumulated in the battery to the power supply circuit 33. The battery may be any of a lithium ion battery, a sodium ion battery, and the like, for example.

The power supply switch 36 controls either power on or power off as the supply state of power to the host system 10 every time a depressing operation is accepted. When the depressing operation is accepted, the power supply switch 36 outputs a depressing signal indicating depressing to the EC 31. When the information processing apparatus 1 is powered off and the depressing signal is input from the power supply switch 36, the EC 31 causes the power supply circuit 33 to start the supply of power to the devices of the information processing apparatus 1 (application of power). When power is supplied to the information processing apparatus 1 and the depressing signal is input from the power supply switch 36, the EC 31 causes the host system 10 to execute the stop process (shutdown).

Next, operations of the host system 10 will be described. The functions of the host system 10 are realized by executing various programs by the CPU 11 in cooperation with the main memory 12, the chipset 21, and the other hardware. FIG. 2 is a schematic block diagram illustrating a functional configuration example of the host system 10 according to one or more embodiments. The host system 10 includes a firmware management module 10a and a power management module 10b.

The firmware management module 10a manages pieces of firmware that are used in the information processing apparatus 1. The firmware management module 10a holds a management table that indicates pieces of version information of the pieces of firmware applied to individual devices constituting the information processing apparatus 1. The firmware management module 10a executes update processes of the pieces of firmware. Each of the update processes of the pieces of firmware includes, for example, a detection task, an acquisition task, and an update task. The update process may be executed as a part of a maintenance process. The firmware management module 10a may execute firmware management in a predetermined maintenance period (e.g., a specified time slot of a day or a week), or may execute the firmware management at an arbitrary time in accordance with a user instruction. The user instruction is transmitted by an operation signal input from the input device 32.

In the detection task, the firmware management module 10a detects a newer version of firmware than a version (may be called “present version” in the present invention) applied to the own apparatus at that time point (present time point). For example, the firmware management module 10a queries a provision source device (not illustrated) that provides firmware about the latest version every predetermined period. In that case, the firmware management module 10a transmits an inquiry command for making an inquiry about providable firmware to the provision source device. The provision source device can be configured to include a database for saving a providable version of firmware for each device or access the database. The provision source device is a firmware management server, for example. The provision source device may vary for each device (may be called “target device” in the present invention) to which firmware is applied. The provision source device is, for example, a cloud server connected to the information processing apparatus 1 through the Internet.

When receiving the inquiry command from the information processing apparatus 1, the provision source device generates response information indicating versions (may be called “providable versions” in the present invention) of providable pieces of firmware at that time point. The provision source device transmits, as a response to the inquiry command, the generated response information to the information processing apparatus 1 that is an inquiry source. The firmware management module 10a refers to the management table, and specifies a version different from the present version applied to the target device at that time point from among the providable versions indicated by the response information. When there is a plurality of different versions, the firmware management module 10a specifies one version (e.g., latest version) from among the plurality of versions. When the providable versions indicated by the response information include only the present version, the firmware management module 10a does not perform the acquisition task and the update task to be described later.

Note that a target device and a version may be designated by a user's operation. In that case, the firmware management module 10a specifies the present version for the target device with reference to the management table, and determines whether the version designated by the user's operation is equivalent to the present version. When the version designated by the user's operation is the present version, the firmware management module 10a does not perform the acquisition task and the update task to be described later.

In the acquisition task, the firmware management module 10a accesses the ROM 22, and determines whether a version of firmware is saved for the target device specified by the detection task. When the version of firmware is saved, the firmware management module 10a proceeds to the update task without acquiring the firmware from the provision source device. When the specified version of firmware is not saved in the ROM 22, the firmware management module 10a acquires the specified version of firmware for the target device from the provision source device. In that case, the firmware management module 10a transmits a request command for requesting the specified version of firmware for the target device to the provision source device.

The provision source device reads the version of firmware designated by the request command. As a response to the request command, the provision source device transmits the read firmware to the information processing apparatus 1 that is a request source. The firmware management module 10a receives the version of firmware designated by the request command from the provision source device, and saves the received firmware in the ROM 22. At this time, the present version of firmware saved in the ROM 22 may be removed, or may be overwritten by the version of firmware that is newly saved.

In the update task, the firmware management module 10a removes the present version of firmware saved in a working memory of the target device. Before removing the present version of firmware for the predetermined target device, the firmware management module 10a saves (evacuates) image data indicating an execution state of a running program including the firmware in the auxiliary storage device 23. After that, the firmware management module 10a stops (turns off) the supply of power to the target device. At this time, the firmware saved in the working memory of the target device is removed. Then, the firmware management module 10a restarts (turns on) the supply of power to the target device, reads the specified version of firmware from the ROM 22, and loads the read firmware into the working memory of the target device. When the image data is saved in the auxiliary storage device 23, the firmware management module 10a reads the image data from the auxiliary storage device 23, and loads the read image data into the working memory. After that, the firmware management module 10a starts executing the firmware loaded into the working memory. The firmware management module 10a updates the management table so that the new version of firmware is set as the present version of firmware.

The working memory may be a volatile memory (e.g., RAM) provided in the target device (e.g., the management engine 21m or the EC 31). When the target device is the host device, the working memory may be the main memory 12. Unlike peripheral devices (e.g., the management engine 21m and the EC 31) other than the host device, the power off is equivalent to shutdown, and firmware to be updated is BIOS.

The loading of the new version of BIOS to be updated from the ROM 22 into the main memory 12 is executed in the boot process after powering on the host system 10.

The power management module 10b monitors the operations of the host system 10, and controls the power consumption of the host system 10. The control parameter of the host system 10 includes a first limit power, for example. The first limit power is a power limit value equivalent to the rated power, and may be called PL1 (power limit 1) or long term power limit. The rated power is a threshold for allowing a moving average value of power consumption to temporarily exceed this value but for restricting the moving average value of the power consumption from constantly (e. g., to continue for several seconds to several tens of seconds or more) exceeding this value. A window length (observation period related to the moving average of the power consumption) in the moving average is about 1 to 10 seconds, for example.

The power management module 10b controls the power consumption of the host system 10 so that the moving average value of the power consumption is equal to or less than the rated power. The power management module 10b monitors the power consumption of the host system 10, and when a time during which the power consumption exceeds the rated power continues for a predetermined reference duration time t (e.g., 0.2 to 1 second) or more, decreases the power consumption of the host system 10 until the moving average value of the power consumption is equal to or less than the rated power. Generally, the power consumption of the CPU 11 becomes higher as an operating voltage is higher, and becomes higher as a clock frequency is higher. The power management module 10b changes one or both of the operating voltage and clock frequency of the CPU 11 to restrict the power consumption of the host system 10 to the rated power or less in perspective.

The power management module 10b according to one or more embodiments monitors the operating status of the firmware management module 10a, and controls the power consumption related to the update process of the firmware.

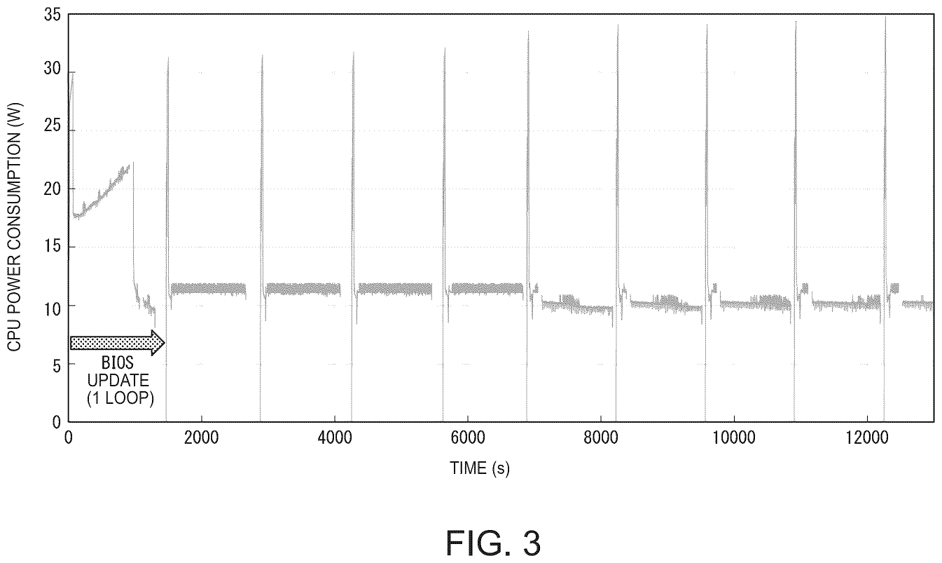

Herein, within a range where an amount of decrease in a processing speed of the update process with respect to an amount of decrease in a power limit value of the host system 10 is smaller than the predetermined reference amount, the power management module 10b decreases the power limit value. Generally, the lower the power limit value is, the slower the processing speed is, but a ratio of the amount of decrease in the processing speed to the amount of decrease in the power limit value is not necessarily constant. FIG. 3 illustrates the transition of the power consumption of the CPU in a situation where updating (BIOS update) of the BIOS is repeated.

In the example of FIG. 3, power consumption of the CPU in the first update process is larger than power consumption in the second and subsequent update processes. However, it cannot be said that a required time for the first update process is meaningfully smaller than a required time for the second and subsequent update processes. One or more embodiments focuses on this point, and suppresses the decrease in the processing speed and searches for the power limit value that results in less power consumption by decreasing the power limit value in the range where the ratio of the amount of decrease in the processing speed to the amount of decrease in the power limit value is small.

More specifically, the power management module 10b determines whether the firmware management module 10a is executing the update process (may be called “update” in the present invention) of the firmware. When being executing the update process of the firmware, the power management module 10b measures a processing speed (may be called “update speed” in the present invention) for the update process. The power management module 10b measures a processing time (may be called “update time” in the present invention) required for the update process of the firmware, and measures a capacity (may be called “update size” in the present invention) of the firmware for updating. The power management module 10b divides the measured capacity by the processing time to determine the processing speed.

For example, until the amount of decrease from the processing speed of the previous update process to the processing speed of the latest update process exceeds the predetermined reference amount, the power management module 10b decreases the power limit value for each update process by the predetermined amount of decrease. Herein, when the amount of decrease from the processing speed of the previous update process to the processing speed of the latest update process is equal to or less than the predetermined reference amount, the power management module 10b decreases the power limit value at that time point at a constant rate of decrease. When the amount of decrease from the processing speed of the previous update process to the processing speed of the latest update process exceeds the reference amount, the power management module 10b does not decrease the power limit value. At this time, the power management module 10b may increase the power limit value to compensate for the previous amount of decrease.

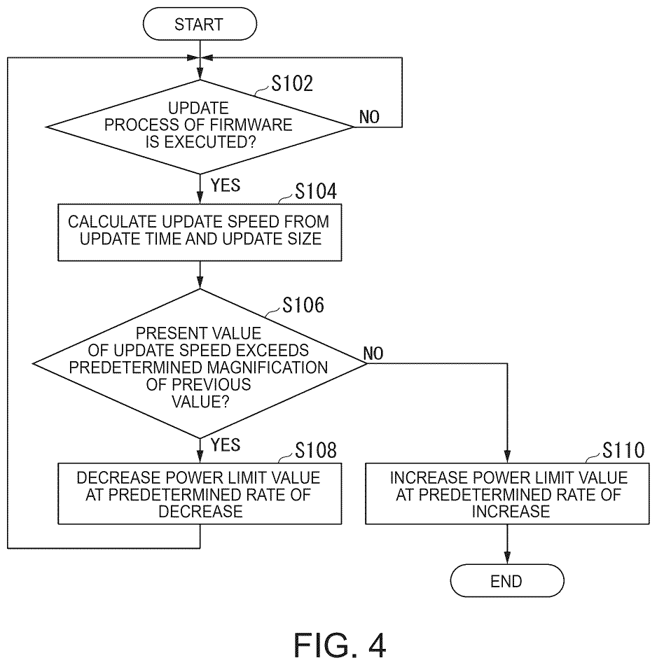

Next, an example of a power limit value setting process according to one or more embodiments will be explained. FIG. 4 is a flowchart illustrating the power limit value setting process according to one or more embodiments. In this regard, however, the host system 10 sets a value equal to or greater than the normal power consumption as an initial value of the power limit value for the update process. The parameters such as the power limit value, the initial value, the rate of increase, and the rate of decrease may be set independently for each target device.

The power management module 10b monitors the operating status of the firmware management module 10a, and determines whether the update process (firmware update) of the firmware is executed (Step S102). When the update process is executed (Step S102: YES), the process proceeds to Step S104. When the update process is not executed (Step S102: NO), the process repeats Step S102. The power management module 10b measures a required time for the update process as an update time, and measures a capacity (update size) of the firmware for the update process (Step S104). The power management module 10b divides the measured update size by the update time to calculate an update speed.

The power management module 10b determines the calculated latest update speed (present value) exceeds a predetermined magnification (e.g., 0.8 to 1.0 time) of the update speed (previous value) for the just previous update process (Step S106). When it is determined that when it exceeds the magnification (Step S106: YES), the process proceeds to Step S108. When it is determined that when it does not exceed the magnification (Step S106: NO), the process proceeds to Step S110.

The power management module 10b decreases the power limit value set in the host system 10 at that time point at a predetermined rate of decrease (e.g., to 0.7 to 0.9 times of the present value) (Step S108). After that, the process returns to Step S102. The power management module 10b increases the power limit value set in the host system 10 at that time point at a predetermined rate of increase (e. g., to 1.1 to 1.4 times of the present value) (Step S110). The rate of increase in the power limit value in Step S110 may be set to compensate for the decrease in the power limit value in Step S108. For example, when the power limit value is decreased to 0.8 times in Step S108, the rate of increase may be set so that the power limit value is increased to 1.25 times in Step S110. After that, the process of FIG. 4 is ended.

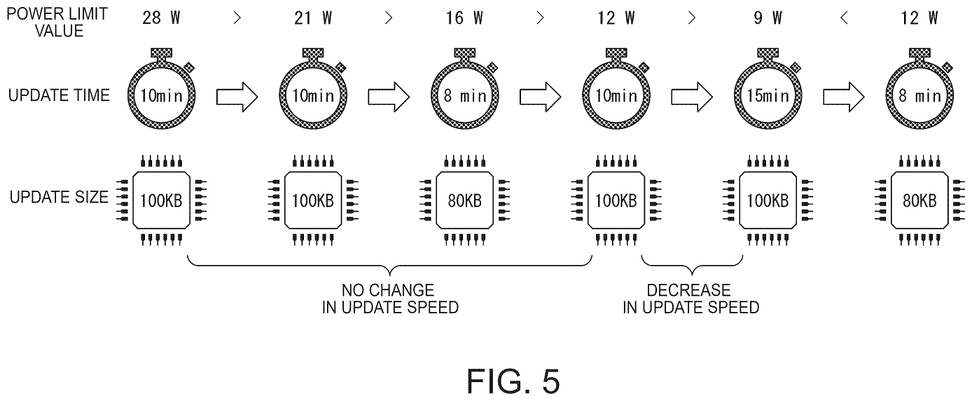

Next, an execution example of the power limit value setting process according to one or more embodiments will be described. FIG. 5 is an explanatory diagram illustrating an execution example of the power limit value setting process according to one or more embodiments. In the execution example illustrated in FIG. 5, the initial value of the power limit value is 28W, the predetermined magnification of the update speed in Step S106 is 0.9 times, the rate of decrease in Step S108 is ¾ of the present value, and the rate of increase in Step S110 is 4/3 of the present value.

In the first update process, because the update time is 10 minutes and the update size is 100 kB, the update speed is 10 kB/min. The power management module 10 b decreases the power limit value to 21 W that is ¾ of the initial value 28 W. In the second update process, because the update time is 10 minutes and the update size is 100 kB, the update speed is 10 kB/min. Because the second update speed is equal to the first update speed, the power management module 10b decreases the power limit value to 16 W that is about ¾ of 21 W.

In the third update process, because the update time is 8 minutes and the update size is 80 kB, the update speed is 10 kB/min. Because the third update speed is equal to the second update speed, the power management module 10b decreases the power limit value to 12 W that is ¾ of 16 W.

In the fourth update process, because the update time is 10 minutes and the update size is 100 kB, the update speed is 10 kB/min. Because the fourth update speed is equal to the third update speed, the power management module 10b decreases the power limit value to 9 W that is ¾ of 12 W.

In the fifth update process, because the update time is 15 minutes and the update size is 100 kB, the update speed is 6.7 KB/min. Because the fifth update speed is equal to or less than 0.9 times of the fourth update speed, the power management module 10 b increases the power limit value to 12 W that is 4/3 of 9 W. In the sixth update process, because the update time is 8 minutes and the update size is 80 kB, the update speed is 10 kB/min. After that, the process of FIG. 4 is ended, and the power limit value for the update process of the firmware is set to 12 W.

Note that the descriptions of FIGS. 4 and 5 indicate a change amount in the power limit value from the previous value to the present value by using a rate of increase, a rate of decrease, or a magnification of the present value to the previous value but the embodiments are not limited to this. The change amount in the power limit value may be indicated by using a difference between the previous value and the present value. Moreover, a change amount in the update speed from the previous value to the present value is indicated by using a magnification of the present value to the previous value, but the embodiments are not limited to this. The change amount in the update speed may be indicated by using a rate of decrease or a difference between the previous value and the present value.

In the processes illustrated in FIG. 4, the process of Step S110 may be omitted. In that case, when it is determined that the present value of the update speed in Step S106 does not exceed the predetermined magnification of the previous value of the update speed (Step S106: NO), the power management module 10b ends the process of FIG. 4.

As described above, the information processing apparatus 1 according to one or more embodiments includes the host system 10 that executes the update processes of the firmware. The host system 10 measures the processing speed for each the update processes, and decreases the power limit value when the amount of decrease in the processing speed (i.e., update speed) with respect to the amount of decrease in the power limit value of the host system 10 is equal to or less than the predetermined reference amount. According to this configuration, when the processing speed is not decreased or when the amount of decrease is small, the power limit value is controlled to be decreased. For that reason, the prolongation of the required time of the update process of the firmware can be suppressed and the power consumption can be reduced.

Note that the host system 10 may decrease the power limit value by the predetermined amount of decrease when the amount of decrease from the processing speed of the previous update process to the processing speed of the latest update process is equal to or less than the reference amount.

According to this configuration, the power limit value is adaptively adjusted so that the processing speed is maintained based on the transition of the processing speed measured each time the update process of the firmware is executed.

The rate of decrease in the power limit value may be constant. According to this configuration, the amount of decrease can become smaller as the power limit value is smaller due to simple calculation. When adjusting the power limit value while decreasing the power limit value to a smaller value, the power limit value can be efficiently adjusted until the amount of decrease exceeds the predetermined reference amount.

When the amount of decrease from the processing speed of the previous update process to the processing speed of the latest update process exceeds the reference amount, the host system 10 may increase the power limit value. According to this configuration, even if the processing speed conspicuously decreases due to the decrease in the power limit value, the original processing speed can be restored by increasing the power limit value to compensate for its decrease.

Note that the firmware to be updated may be BIOS. Moreover, in the information processing apparatus 1 that includes embedded controllers (e.g., the management engine 21m and the EC 31), the firmware to be updated may be any of pieces of firmware (e.g., MEFW and ECFW) of the embedded controllers.

As described above, although the embodiments of the present invention have been described with reference to the drawings, the specific configuration is not limited to the above embodiments and also includes designs etc. that do not depart from the scope of the present invention. The configurations described in the above embodiments can be arbitrarily combined.

### DESCRIPTION OF SYMBOLS

1 information processing apparatus
10 host system
10a firmware management module
10b power management module
11 CPU
12 main memory
13 GPU
14 display
21 chipset
21m management engine
22 ROM
23 auxiliary storage device
25 communication module
26 input/output interface
31 EC
32 input device
33 power supply circuit
36 power supply switch

What is claimed is:

1. An information processing apparatus comprising:
a host system that executes update processes of firmware,
the host system being configured to:
measure a processing speed for each of the update processes; and
decrease a power limit value of the host system when an amount of decrease in the processing speed with respect to an amount of decrease in the power limit value is equal to or less than a predetermined reference amount.

2. The information processing apparatus according to claim 1, wherein the host system is configured to decrease the power limit value by a predetermined amount of decrease when an amount of decrease from a processing speed of a previous update process to a processing speed of a latest update process among the processing speeds of the update processes is equal to or less than the reference amount.

3. The information processing apparatus according to claim 2, wherein a rate of decrease of the power limit value is constant.

4. The information processing apparatus according to claim 2, wherein the host system is configured to increase the power limit value when the amount of decrease from the processing speed of the previous update process to the processing speed of the latest update process exceeds the reference amount.

5. The information processing apparatus according to claim 1, wherein the firmware includes a basic input/output system (BIOS).

6. The information processing apparatus according to claim 1, further comprising:
an embedded controller, wherein
the firmware includes firmware of the embedded controller.

7. A control method executed by an information processing apparatus that executes update processes of firmware, the control method comprising:
measuring a processing speed for each of the update processes; and
decreasing a power limit value of a host system when an amount of decrease in the processing speed with respect to an amount of decrease in the power limit value is equal to or less than a predetermined reference amount.
